(19) United States
(12) Patent Application Publication
(10) Pub. No.: US 2025/0380346 A1
(43) Pub. Date: Dec. 11, 2025

(54) LED LAMP FOR IMPROVING VISUAL EFFECT

(71) Applicant: Shangyou Jianyi Lighting Product Co., LTD., Ganzhou (CN)

(72) Inventor: Yaowen He, Ganzhou (CN)

(21) Appl. No.: 19/003,289

(22) Filed: Dec. 27, 2024

(30) Foreign Application Priority Data
Jun. 11, 2024 (CN) 2024107457793

(51) Int. Cl. H05B 47/165; H05B 45/10; H05B 45/20; H05B 45/325; H05B 47/155; H05B 47/175

(52) U.S. Cl. CPC H05B 47/165; H05B 45/10; H05B 45/20; H05B 45/325; H05B 47/155; H05B 47/198

(57) ABSTRACT

An LED lamp for improving a visual effect includes: a first illuminating segment and a second illuminating segment with the same specifications, a first address coder-decoder for enabling n LED beads in the first illuminating segment to constitute a first LED logic unit, and a second address coder-decoder for enabling n LED beads in the second illuminating segment to constitute a second LED logic unit. The first LED logic unit is in backward-forward cascade connection to the second LED logic unit; and the LED lamp further synchronously controls every color channel of all the LED beads in the first LED logic unit and the second LED logic unit through the first address coder-decoder and the second address coder-decoder. The present disclosure realizes an equal effect of color depths of every color channel, or indirect expansion of color channels.

### CROSS-REFERENCE TO RELATED APPLICATION

This application claims priority from the Chinese patent application 2024107457793 filed Jun. 11, 2024, the content of which is incorporated herein in the entirety by reference.

### TECHNICAL FIELD

The present disclosure relates to the field of illumination, in particular to an LED lamp for improving a visual effect.

### BACKGROUND

To take an LED lamp string with 8 color depths (an 8-bit lamp for short), its LED beads are RGB three-in-one beads. Even though it includes 80 LED beads, a signal of the lamp string always employs 8-digit binary data to control each color channel of all the LED beads.

Users have a requirement for improving visual effects of LED lamps, but for the time being, a physical color depth of any color channel of each LED bead cannot be rapidly improved.

Therefore, under the circumstance that the physical color depth of any color channel of each LED bead cannot be significantly improved, the art is in urgent need of new ways for improving the visual effects of the LED lamps.

### SUMMARY

In view of this, the present disclosure provides an LED lamp for improving a visual effect. The LED lamp at least includes:
a first illuminating segment and a second illuminating segment.

The first illuminating segment includes n LED beads, where n is larger than or equal to 3; and
specifications of the second illuminating segment are exactly the same as those of the first illuminating segment, and the second illuminating segment also includes n LED beads.

Wherein,
the first illuminating segment is connected to a first address coder-decoder, wherein the first address coder-decoder is configured to code addresses of the plurality of LED beads in the first illuminating segment, so that the n LED beads in the first illuminating segment constitute a first LED logic unit;
the second illuminating segment is connected to a second address coder-decoder, wherein the second address coder-decoder is configured to code addresses of the plurality of LED beads in the second illuminating segment, so that the n LED beads in the second illuminating segment constitute a second LED logic unit;
the first LED logic unit is in backward-forward cascade connection to the second LED logic unit; and
the LED lamp further expands and synchronously controls every color channel of all the LED beads in the first LED logic unit and the second LED logic unit through the first address coder-decoder and the second address coder-decoder and via a combination of all LED logic units.

Preferably,
each LED bead at least includes a color channel, wherein each color channel includes any or a combination of the following: a red color channel R, a green color channel G, and a blue color channel B, and each color channel supports 2^{m} brightness control, where m indicates a depth of each color channel.

Preferably,
m equals 8 or 10.

Preferably,
the first address coder-decoder resolves, based on a preset protocol and coding of the addresses of the plurality of LED beads in the first LED logic unit, a signal corresponding to the plurality of LED beads in the first LED logic unit from signals corresponding to all i illuminating segments; and
the second address coder-decoder resolves, based on a preset protocol and coding of the addresses of the plurality of LED beads in the second LED logic unit, a signal corresponding to the plurality of LED beads in the second LED logic unit from the signals.

Preferably,
all the illuminating segments are in parallel connection or series connection.

Preferably,
the LED lamp further includes an i^{th} illuminating segment, and i ranges from 3 to N, wherein all illuminating segments of the LED lamp are the same in specifications;
the i^{th} illuminating segment is connected to an i^{th} address coder-decoder, wherein the i^{th} address coder-decoder is configured to code addresses of a plurality of LED beads in the i^{th} illuminating segment, so that n LED beads in the i^{th} illuminating segment constitute an i^{th} LED logic unit;
all logic units from the first LED logic unit to an N^{th} LED logic unit are in backward-forward cascade connection to one another sequentially; and
the LED lamp further synchronously controls every color channel of all the LED beads from the first LED logic unit to the N^{th} LED logic unit through the first address coder-decoder to the N^{th} address coder-decoder.

Preferably,
in a case that m equals 8, each color channel of each LED bead has 8 color depths, with brightness varying from 0 to 255; and
in a case that N equals 10, when the LED lamp synchronously controls, through the first address coder-decoder to a 10^{th} address coder-decoder, each color channel of all the LED beads from the first LED logic unit to a 10^{th} LED logic unit, each color channel is expanded to a total of N×m=10×8=80 color depths.

Preferably,
the first address coder-decoder resolves, based on a preset protocol and coding of the addresses of the plurality of LED beads in the first LED logic unit, a signal corresponding to the plurality of LED beads in the first LED logic unit from signals corresponding to all i illuminating segments;
the second address coder-decoder resolves, based on a preset protocol and coding of the addresses of the plurality of LED beads in the second LED logic unit, a signal corresponding to the plurality of LED beads in the second LED logic unit from the signals;
the i^{th} address coder-decoder resolves, based on a preset protocol and coding of the addresses of the plurality of LED beads in the i^{th} LED logic unit, a signal corresponding to the plurality of LED beads in the i^{th} LED logic unit from the signals; and
the N^{th} address coder-decoder resolves, based on a preset protocol and coding of addresses of the plurality of LED beads in the N^{th} LED logic unit, a signal corresponding to the plurality of LED beads in the N^{th} LED logic unit from the signals,
so that the LED lamp synchronously controls every color channel of all the LED beads from the first LED logic unit to the N^{th} LED logic unit through the first address coder-decoder to the N^{th} address coder-decoder.

Preferably,
when any illuminating segment is replaced with a new illuminating segment due to malfunction, an address coder-decoder corresponding to the illuminating segment may recode addresses of LED beads in the new illuminating segment.

Preferably,
any address coder-decoder, other than the first address coder-decoder, can code the addresses of the plurality of LED beads in a corresponding illuminating segment in a shifting mode.

In summary, under the circumstance that a physical color depth of any color channel of each LED bead cannot be significantly improved, the present disclosure logically divides any illuminating segment with the plurality of LED beads to obtain the corresponding logic unit, and then uses a combination of a plurality of logic units to realize an equal effect of color depths of every color channel, or indirect expansion of color channels. Because current LED beads have a small superficial area, through such expansion, the visual effect of the LED lamp is improved, and more diversified and subtle colors are easily displayed.

### BRIEF DESCRIPTION OF DRAWINGS

In order to provide a clearer description of the technical solutions in the embodiments of the present disclosure, a brief introduction will be provided below regarding the accompanying drawings used in the embodiments. It should be understood that the following accompanying drawings are merely illustrative of some embodiments of the present disclosure and should not be considered as limiting the scope thereof. Those skilled in the art will appreciate that, without exercising inventive efforts, other relevant accompanying drawings can be obtained based on these accompanying drawings.

FIG. 1 is a schematic structural diagram of an LED lamp in a parallel connection solution provided by an embodiment of the present disclosure;

FIG. 2 is a schematic structural diagram of an LED lamp in a series connection solution provided by an embodiment of the present disclosure;

FIG. 3 to FIG. 6 are schematic diagrams of LED beads of a 40*40 dimension respectively in parallel connection and series connection and at different voltage levels.

It should be noted that the above accompanying drawings do not limit the dimensional ratios of wires, LED beads, current-limiting units, various ICs, resistors and the like. The accompanying drawings are more illustrative of the structure, connection relationships, spatial position relationships, etc.

### DETAILED DESCRIPTION OF THE INVENTION

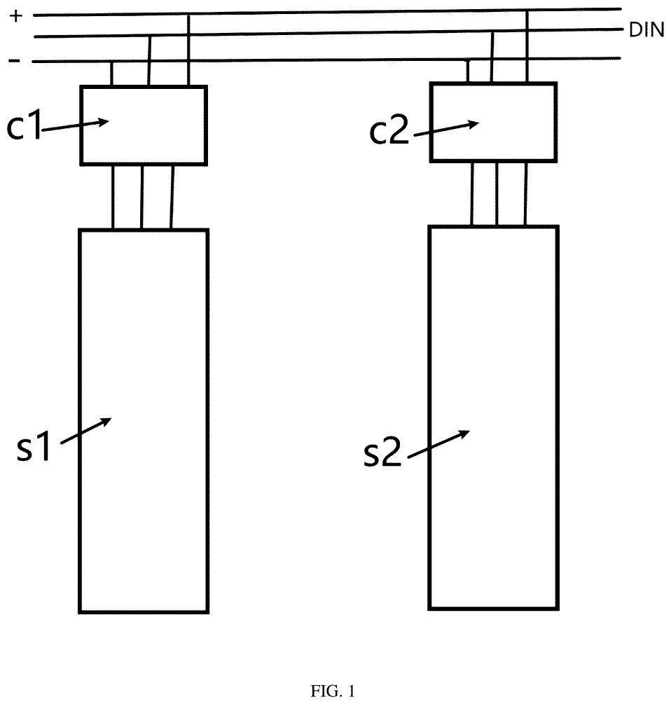

In order to make objectives, technical solutions and advantages of embodiments of the present disclosure clearer, the technical solutions in the embodiments of the present disclosure will be described clearly and comprehensively in conjunction with FIG. 1 to FIG. 6 in the embodiments of the present disclosure. Apparently, the described embodiments are only a part of the embodiments of the present disclosure, rather than all the embodiments. Components of the embodiments of the present disclosure described and illustrated in the accompanying drawings can be arranged and designed in various configurations.

Therefore, the detailed description provided below with respect to the embodiments of the present disclosure shown in the accompanying drawings is not intended to limit the scope of the claimed disclosure. It is solely representative of selected embodiments of the present disclosure. All other embodiments obtained by those skilled in the art without exercising inventive efforts based on the embodiments disclosed herein are also within the scope of protection of the present disclosure.

It should be noted that: similar reference numerals and letters represent similar elements in the accompanying drawings below. Accordingly, once an item is defined in one drawing, further definition and explanation thereof are not necessary in subsequent accompanying drawings.

It should be noted in the description of the present disclosure that the terms “up”, “down”, “inside”, “outside”, and other directional or positional relationships are based on the orientations or positions shown in the accompanying drawings, or the customary orientations or positions when using the product of the present disclosure. These terms are used for facilitating description and simplifying the description, and do not indicate or imply that the device or component referred to must have a specific orientation, or be constructed and operated in a specific orientation. Therefore, they should not be understood as limiting the present disclosure.

In addition, the terms “first”, “second”, etc. are used only for purposes of distinguishing between descriptions, and should not be understood as indicating or implying relative importance.

It should be noted that, unless conflicting, features in the embodiments of the present disclosure may be combined with each other.

In one embodiment, the present disclosure provides an LED lamp for improving a visual effect. The LED lamp at least includes:
a first illuminating segment and a second illuminating segment.

The first illuminating segment includes n LED beads, where n is larger than or equal to 3; and
specifications of the second illuminating segment are exactly the same as those of the first illuminating segment, and the second illuminating segment also includes n LED beads.

Wherein,
the first illuminating segment is connected to a first address coder-decoder, wherein the first address coder-decoder is configured to code addresses of the plurality of LED beads in the first illuminating segment, so that the n LED beads in the first illuminating segment constitute a first LED logic unit;
the second illuminating segment is connected to a second address coder-decoder, wherein the second address coder-decoder is configured to code addresses of the plurality of LED beads in the second illuminating segment, so that the n LED beads in the second illuminating segment constitute a second LED logic unit;
the first LED logic unit is in backward-forward cascade connection to the second LED logic unit; and
the LED lamp further expands and synchronously controls every color channel of all the LED beads in the first LED logic unit and the second LED logic unit through the first address coder-decoder and the second address coder-decoder and via a combination of all LED logic units.

In this way, under the circumstance that a physical color depth of any color channel of each LED bead cannot be significantly improved, the present disclosure logically divides any illuminating segment with the plurality of LED beads to obtain the corresponding logic unit, and then uses a combination of a plurality of logic units to realize an equal effect of color depths of every color channel, or indirect expansion of color channels. Because current LED beads have a small superficial area, through such expansion, the visual effect of the LED lamp is improved, and more diversified and subtle colors are easily displayed. It should be understood that, a process of synchronous control involves decoding of the addresses because the present disclosure needs to satisfy the premise for correct functioning of each LED bead. It should be noted that, the address coder-decoders may be based on hardware, or may be based on an embedded program. A coding implementation manner of hardware may be a simple circuit such as a shifter or other circuits, and corresponding decoding may also be realized by a shifter or other circuits.

Most typically, the embodiment disclosed by the present disclosure is preferably applied to LED lamp strings, and any address coder-decoder and the corresponding illuminating segment are integrated on one string.

In another embodiment,
each LED bead at least includes a color channel, wherein each color channel includes any or a combination of the following: a red color channel R, a green color channel G, and a blue color channel B, and each color channel supports 2^{m} brightness control, where m indicates a depth of each color channel.

Typically,
m equals 8 or 10.

It should be understood that, in a case that m equals 8, a depth of each LED bead is 256, with brightness varying from 0 to 255.

In another embodiment,
the LED beads are RGB three-in-one beads.

In another embodiment,
the first address coder-decoder resolves, based on a preset protocol and coding of the addresses of the plurality of LED beads in the first LED logic unit, a signal corresponding to the plurality of LED beads in the first LED logic unit from signals corresponding to all i illuminating segments; and
the second address coder-decoder resolves, based on a preset protocol and coding of the addresses of the plurality of LED beads in the second LED logic unit, a signal corresponding to the plurality of LED beads in the second LED logic unit from the signals.

Exemplarily, for ease of understanding, in one embodiment, assuming: every 8 LED beads constitute one logic unit, and 2 logic units are involved, then: although any color channel of each LED bead still adjusts its brightness according to 8-digit binary data it receives (i.e. 256 levels of brightness control), through collaboration of the 2 logic units and via synchronous control, the brightness of any color channel of each LED bead may be precisely controlled, so the present disclosure can realize more diversified and subtle colors. In this way, although the embodiment is still based on the original 256 levels of brightness control of each LED bead, it realizes an equal effect of color depths of every color channel, or indirect expansion of color channels, through synchronous control of the plurality of logic units.

In another embodiment,

To take the LED lamp being a lamp string as an example, the LED beads of the lamp string are, for example, WS2812 or other LED beads, and data communication and control can be performed through a one-wire protocol (such as SPI or a specialized OneWire protocol). It can be understood that, hardware-based address coder-decoders realize control of the LED beads through the above logic units, so as to realize indirect expansion of the color channels and thus realize more diversified colors and animation effects. A coding implementation manner of hardware may be a simple circuit such as a shifter or other circuits, and corresponding decoding may also be realized by a shifter or other circuits.

Exemplarily, a hardware-based address coder-decoder includes an integrated circuit (IC). The integrated circuit is configured to receive an input signal, and the signal carries IDs of the logic units, and address, brightness and color information (for example, an RGB value) of each bead.

Or, in another example, the hardware-based address coder-decoder may also include a micro control unit (MCU). Compared with the aforementioned integrated circuit (IC), it can be understood that a cost of the MCU is higher than that of the IC. If the hardware-based address coder-decoder is implemented through the MCU, the micro control unit transmits pulse width modulation (PWM) signals through a designated pin, and these signals may also carry the IDs of the logic units, and the address, brightness and color information of each bead.

It can be found that, either the hardware-based address coder-decoder is implemented through the IC or the MCU, it actually generates the abovementioned signals through an agreed protocol, and finally sends the signals to the LED beads, thus enabling the LED beads to operate normally.

In some potential advanced applications, if the display of the controlled LED beads is more complex, and the amount of information in the signal is large and involves high-speed transmission, then, without considering the cost, other specialized hardware-based coder-decoder chips may be used to collaborate with the micro control unit (MCU) in processing complex signal coding and decoding, so as to relieve the burden of the micro control unit and improve the overall system efficiency.

For the hardware-based address coder-decoder,
the signals or data is usually transmitted serially and with specific timing and coding manners (for example, 8-bit binary data is adopted for each color channel, with additional synchronization and error check bits if necessary) to ensure accurate transmission and resolution. The hardware-based address coder-decoder realizes the function of coding and decoding the address of each LED bead in the logic unit and further down. Each LED bead, in turn, is often controlled by its own integrated circuit (IC). After data from the LED bead is received, the IC adjusts its internal PWM signals according to decoded information, thus controlling the brightness and color of the LED bead.

With regard to timing generation and signal shaping in a communication or transmission process, it can be understood that, in order to ensure correct transmission of data, a sending end needs to precisely control a pulse width and spacing of the signals. This may be achieved through timing generation and signal shaping circuits. For this part, reference may be made to the prior art to ensure the accurate reading of data and prevent signal distortion.

In another embodiment,
all the illuminating segments are in parallel connection or series connection.

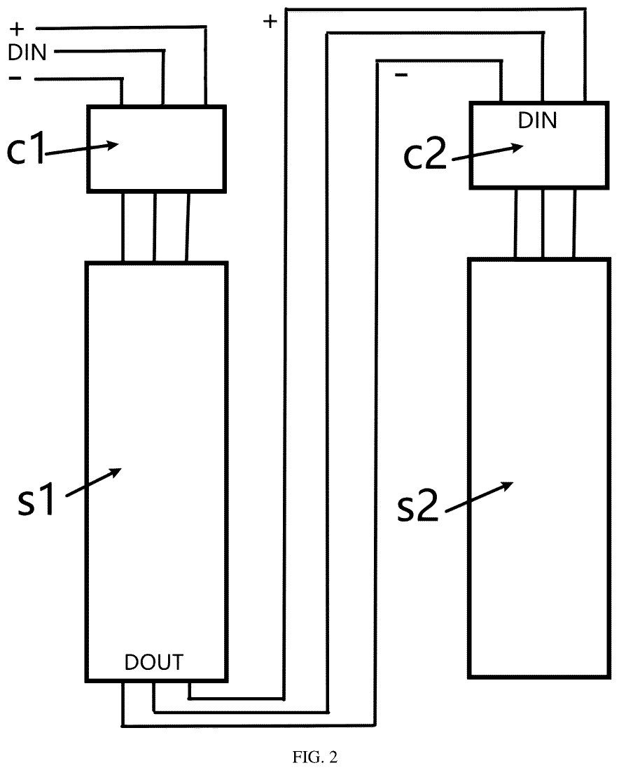

Exemplarily, referring to FIG. 1 and FIG. 2, c1 and c2 respectively represent the first address coder-decoder and the second address coder-decoder, s1 and s2 respectively represent the first illuminating segment and the second illuminating segment, and + and − power supply wires as well as a DIN signal line are also shown in the figures.

i) Referring to FIG. 1, in a case of parallel connection, the two wires supplying power (for example, an anode wire and a cathode wire) are connected to all the illuminating segments as a bus, and all the address coder-decoders are connected to the same signal line. At the moment, any the address coder-decoders resolves signals of the plurality of LED beads in the LED logic unit corresponding to the address coder-decoder;

ii) Referring to FIG. 2, in a case of series connection, the two wires supplying power (for example, the anode wire and the cathode wire) are sequentially connected to all the illuminating segments, and signal lines of all the address coder-decoders are in series connection. At the moment, from the second address coder-decoder on, each address coder-decoder resolves the signals of the plurality of LED beads in the LED logic unit corresponding to the address coder-decoder from a signal output by a preceding address coder-decoder.

In another embodiment,
the LED lamp further includes an i^{th} illuminating segment, and i ranges from 3 to N, wherein all illuminating segments of the LED lamp are the same in specifications;
the i^{th} illuminating segment is connected to an i^{th} address coder-decoder, wherein the i^{th} address coder-decoder is configured to code addresses of a plurality of LED beads in the i^{th} illuminating segment, so that n LED beads in the i^{th} illuminating segment constitute an i^{th} LED logic unit;
all logic units from the first LED logic unit to an N^{th} LED logic unit are in backward-forward cascade connection to one another sequentially; and
the LED lamp further synchronously controls every color channel of all the LED beads from the first LED logic unit to the N^{th} LED logic unit through the first address coder-decoder to the N^{th} address coder-decoder.

In another embodiment,
in a case that m equals 8, each color channel of each LED bead has 8 color depths, with brightness varying from 0 to 255; and
in a case that N equals 10, when the LED lamp synchronously controls, through address coder-decoders from the first address coder-decoder to a 10^{th} address coder-decoder, each color channel of all the LED beads from the first LED logic unit to a 10^{th} LED logic unit, each color channel is expanded to a total of N×m=10×8=80 color depths.

As for a product with 80 LED beads in the prior art, signals of the lamp always employ 8-digit binary data to control each color channel of all the LED beads. In comparison, the embodiment may expand each color channel to a total of 80 color depths, and may thus control the LED lamp through 80-digit binary data, thus realizing changes of visual effects.

In another embodiment,
the first address coder-decoder resolves, based on a preset protocol and coding of the addresses of the plurality of LED beads in the first LED logic unit, a signal corresponding to the plurality of LED beads in the first LED logic unit from signals corresponding to all i illuminating segments;
the second address coder-decoder resolves, based on a preset protocol and coding of the addresses of the plurality of LED beads in the second LED logic unit, a signal corresponding to the plurality of LED beads in the second LED logic unit from the signals;
the i^{th} address coder-decoder resolves, based on a preset protocol and coding of the addresses of the plurality of LED beads in the i^{th} LED logic unit, a signal corresponding to the plurality of LED beads in the i^{th} LED logic unit from the signals; and
the N^{th} address coder-decoder resolves, based on a preset protocol and coding of addresses of the plurality of LED beads in the N^{th} LED logic unit, a signal corresponding to the plurality of LED beads in the N^{th} LED logic unit from the signals,
so that the LED lamp synchronously controls every color channel of all the LED beads from the first LED logic unit to the N^{th} LED logic unit through the first address coder-decoder to the N^{th} address coder-decoder.

In this way, the embodiment may, through synchronous control of the plurality of LED beads in each logic unit in the plurality of logic units, create impressive visual effects, such as smoother color transitions and more dynamic light and shadow movements. It realizes creative application of existing color control capabilities.

In another embodiment,
when any illuminating segment is replaced with a new illuminating segment due to malfunction, an address coder-decoder corresponding to the illuminating segment may recode addresses of LED beads in the new illuminating segment.

It can be understood that, the embodiment implies that any address coder-decoder is further configured to maintain the malfunctional illuminating segment connected to it. Actually, LED beads are more prone to malfunction than address coder-decoders, so in most cases, the address coder-decoders are in good condition. When a malfunctional illuminating segment is replaced with a new one, the address coder-decoder and the new illuminating segment are powered and the signal lines between the address coder-decoder and the new illuminating segment are connected. This allows the address coder-decoder to recode the addresses of the LED beads in the new illuminating segment, ensuring that the entire LED lamp can continue to function properly.

In another embodiment,
for any two illuminating segments, the corresponding LED beads have the same initial address coding.

The most significant positive impact of the embodiment is that: when each illuminating segment is an LED lamp string assembly, the addresses of all LED lamp string assembly may be configured to be the same. If a certain illuminating segment needs to be replaced due to needs of maintenance, the corresponding address coder-decoder connected to the illuminating segment may code it.

In another embodiment,
each address coder-decoder further includes a memory. The memory stores address information of the address coder-decoder.

Exemplarily, when the first illuminating segment and the second illuminating segment are independently manufactured, addresses of the 8 LED beads in each illuminating segment are 1-8. When the two illuminating segments mentioned above and the corresponding address coder-decoders constitute the LED lamp, for example, the LED lamp string, because the memory of the address coder-decoder connected to the second illuminating segment stores the address information of 07, the address of the second illuminating segment may be recoded into 9-16 following the address of the last LED bead of the first illuminating segment, and so on.

Therefore, in another embodiment,
any address coder-decoder, other than the first address coder-decoder, can code the addresses of the plurality of LED beads in a corresponding illuminating segment in a shifting mode.

In another embodiment,
the address information of the address coder-decoder is preset. For example, regarding 07 mentioned above, it can be understood that, 07 implies that the address coder-decoder corresponds to 8 LED beads. Where it needs to correspond to 10 LED beads, the address of the address coder-decoder is 09.

Further, in another embodiment,
the address coder-decoder may reset the address information through signal input from the preceding address coder-decoder.

Typically, when the first illuminating segment and the second illuminating segment are in series connection, assuming the current address coder-decoder is connected to the second illuminating segment, the preceding signal output may come from the last LED bead of the first illuminating segment. As mentioned before, the address of the last LED bead of the preceding illuminating segment is 8, so after obtaining the address, the current address coder-decoder may reset the addresses of the address coder-decoder, and code the address of the first LED bead of the second illuminating segment based on the reset addresses of the address coder-decoder, thus further realizing recoding of the addresses of all the LED beads of the second illuminating segment. Actually, in a case of series connection, for the plurality of LED beads in the current LED logic unit, after the last LED bead processes its illumination according to the signal input, the address coder-decoder corresponding to the current LED logic unit may transmit a signal to the address coder-decoder of a subsequent LED logic unit, thus providing new signal output to the LED beads in the subsequent LED logic unit. The signal output may enable the LED beads in the subsequent LED logic unit to precisely identify input signals and ensure normal functioning of all subsequent LED beads.

In another embodiment,
with regard to signal lines among the address coder-decoder and the LED beads in the corresponding illuminating segment, it can be seen from a correspondence between signals transmitted on the signal lines and addresses of the LED beads, a case may be that the address coder-decoder does not recode the addresses of the LED beads, but instead code the signals on the signal lines so that the signals correctly correspond to the LED beads.

It can be understood that the two coding modes may be flexibly selected based on the correspondence between the two. Both modes concern coding the signals involving the addresses, without involving any other data signal, in the narrow sense, for enabling the LED beads to emit light. In either case, the purpose is to drive the LED beads to function correctly, so the present disclosure does not involve changes of any data signal in the narrow sense. Therefore, the preset protocol in the present disclosure refers to a communication protocol between the LED beads and the signals they receive, without any specific regulations. As long as the signals transmitted over the signal lines correspond to the addresses of the LED beads, enabling the correct resolution of addresses and data signals, the requirements are met.

Further, the LED lamp does not require uniform coding of addresses of all illuminating segments based on a specific preference before delivery, and coding of the addresses may be implemented on site upon use. Because the addresses may be recoded through the address coder-decoders, the present disclosure is beneficial to recoding under a circumstance of a malfunctional illuminating segment. For example,
the malfunctional illuminating segment is removed, and then the address coder-decoder is used to recode the addresses of the LED beads in the replaced illuminating segment.

Particularly in the case of implementation via a shifting manner, as mentioned in the previous embodiment, because each address coder-decoder carries the corresponding address information, for example, the aforementioned address coder-decoder stores the address information of 07, in a recoding process, the address coder-decoder naturally determines how many LED beads are grouped into one logic unit. As mentioned before, when the first illuminating segment and the second illuminating segment are independently manufactured, addresses of the 8 LED beads in each illuminating segment are 1-8. When the two illuminating segments mentioned above and the corresponding address coder-decoders constitute the LED lamp, for example, the LED lamp string, because the memory of the address coder-decoder connected to the second illuminating segment stores the address information of 07, the address of the second illuminating segment may be recoded into 9-16 following the address of the last LED bead of the first illuminating segment, and so on.

In another embodiment,
each address coder-decoder has three terminals. The three terminals are integrally designed and are plug-in to facilitate connection of the address coder-decoder to preceding, subsequent and current illuminating segments.

It can be understood that, a plug-in design is beneficial to the assembly and subsequent maintenance of the LED lamp product.

In another embodiment,
the address coder-decoders are used for LED lamps of different voltage degrees including 4.5 V, 5 V, 12 V or 36 V.

In another embodiment,
each address coder-decoder used for LED lamps of higher voltage degrees such as 12 V or 36 V includes a high-voltage-withstanding resistor.

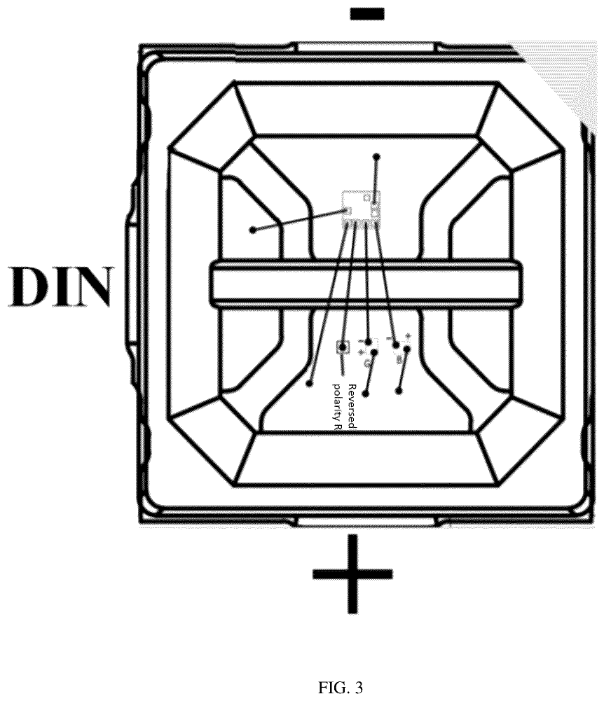

Exemplarily, referring to FIG. 3 to FIG. 6, FIG. 3 to FIG. 6 are schematic diagrams of LED beads of a 40*40 dimension.

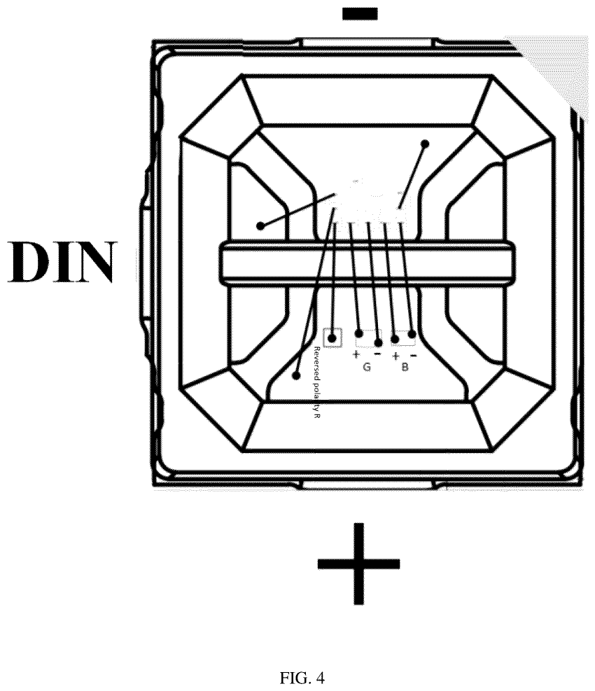

Both FIG. 3 and FIG. 4 illustrate an LED lamp with the first illuminating segment and the second illuminating segment in parallel connection. FIG. 3 and FIG. 4 are different in the degrees of voltages. FIG. 3 illustrates a 5 V scheme, while FIG. 4 illustrates a 12 V scheme.

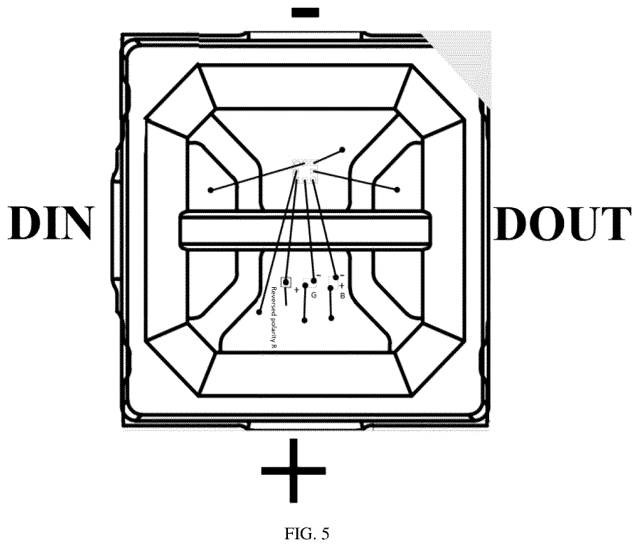

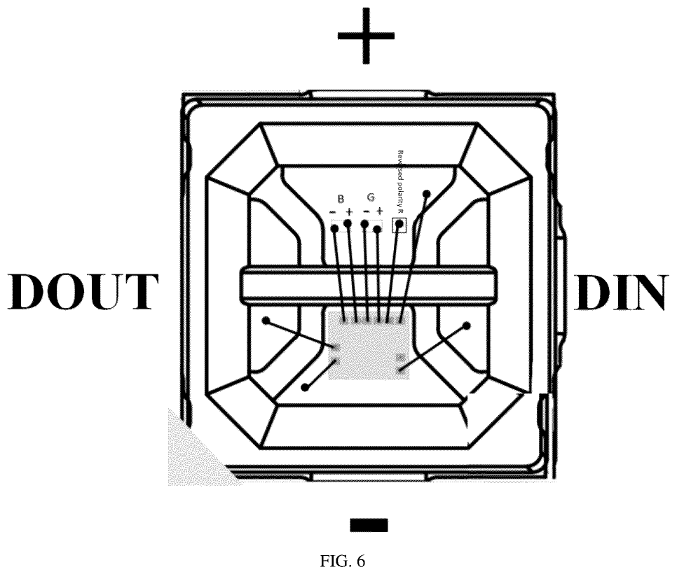

Both FIG. 5 and FIG. 6 illustrate an LED lamp with the first illuminating segment and the second illuminating segment in series connection. FIG. 5 and FIG. 6 are different in the degrees of voltages. FIG. 5 illustrates a 5 V scheme, while FIG. 6 illustrates a 12 V scheme.

It can be found that, the 12 V scheme is different from the 5 V scheme in that it involves an additional resistor and a connecting wire thereof.

In another embodiment,

A working voltage of the LED lamp is 110 V-230 V. Further, the LED lamp is matched with a corresponding AC/DC module.

It can be understood that the present disclosure is not limited to voltages of 110 V or 230 V. Other power supply voltage standards or a broader voltage range may be applied.

In another embodiment,
each address coder-decoder has a Nixie tube. The Nixie tube is configured to display the address information of the address coder-decoder.

Further, the Nixie tube may further display a working status of the address coder-decoder.

In another embodiment,
the Nixie tube is replaced with one or a plurality of LED beads as an indicator. The one or plurality of LED beads are configured to display the working status of the address coder-decoder.

The above description is only specific embodiments of the present disclosure and the scope of protection of the present disclosure is not limited thereto. Any changes or substitutions that can be easily conceived by those skilled in the art within the technical scope disclosed in the present disclosure should be encompassed within the scope of protection of the present disclosure. Therefore, the scope of protection of the present disclosure should be determined by the scope defined in the claims.

1. An LED lamp for improving a visual effect, wherein the LED lamp at least comprises:
a first illuminating segment and a second illuminating segment; wherein,
the first illuminating segment comprises n LED beads, wherein n is larger than or equal to 3; and
specifications of the second illuminating segment are exactly the same as those of the first illuminating segment, and the second illuminating segment also comprises n LED beads;
wherein the first illuminating segment is connected to a first address coder-decoder,
wherein the first address coder-decoder is configured to code addresses of the plurality of LED beads in the first illuminating segment, so that the n LED beads in the first illuminating segment constitute a first LED logic unit;
the second illuminating segment is connected to a second address coder-decoder, wherein the second address coder-decoder is configured to code addresses of the plurality of LED beads in the second illuminating segment, so that the n LED beads in the second illuminating segment constitute a second LED logic unit;
the first LED logic unit is in backward-forward cascade connection to the second LED logic unit; and
the LED lamp further expands and synchronously controls every color channel of all the LED beads in the first LED logic unit and the second LED logic unit through the first address coder-decoder and the second address coder-decoder and via a combination of all LED logic units.

2. The LED lamp according to claim 1, wherein, preferably, each LED bead at least comprises a color channel, wherein each color channel comprises any or a combination of the following: a red color channel R, a green color channel G, and a blue color channel B, and each color channel supports 2^{m} brightness control, wherein m indicates a depth of each color channel.

3. The LED lamp according to claim 1, wherein, m equals 8 or 10.

4. The LED lamp according to claim 1, wherein, the first address coder-decoder resolves, based on a preset protocol and coding of the addresses of the plurality of LED beads in the first LED logic unit, a signal corresponding to the plurality of LED beads in the first LED logic unit from signals corresponding to all i illuminating segments; and
the second address coder-decoder resolves, based on a preset protocol and coding of the addresses of the plurality of LED beads in the second LED logic unit, a signal corresponding to the plurality of LED beads in the second LED logic unit from the signals.

5. The LED lamp according to claim 1, wherein all the illuminating segments are in parallel connection or series connection.

6. The LED lamp according to claim 1, wherein the LED lamp further comprises an i^{th} illuminating segment, and i ranges from 3 to N, wherein all illuminating segments of the LED lamp are the same in specifications;
the i^{th} illuminating segment is connected to an i^{th} address coder-decoder, wherein the i^{th} address coder-decoder is configured to code addresses of a plurality of LED beads in the i^{th} illuminating segment, so that n LED beads in the i^{th} illuminating segment constitute an i^{th} LED logic unit;
all logic units from the first LED logic unit to an N^{th} LED logic unit are in backward-forward cascade connection to one another sequentially; and
the LED lamp further synchronously controls every color channel of all the LED beads from the first LED logic unit to the N^{th} LED logic unit through the first address coder-decoder to the N^{th} address coder-decoder.

7. The LED lamp according to claim 6, wherein in a case that m equals 8, each color channel of each LED bead has 8 color depths, with brightness varying from 0 to 255; and
in a case that N equals 10, when the LED lamp synchronously controls, through address coder-decoders from the first address coder-decoder to a 10^{th} address coder-decoder, each color channel of all the LED beads from the first LED logic unit to a 10^{th} LED logic unit, each color channel is expanded to a total of N×m=10×8=80 color depths.

8. The LED lamp according to claim 6, wherein, the first address coder-decoder resolves, based on a preset protocol and coding the addresses of the plurality of LED beads in the first LED logic unit, a signal corresponding to the plurality of LED beads in the first LED logic unit from signals corresponding to all i illuminating segments;
the second address coder-decoder resolves, based on a preset protocol and coding of the addresses of the plurality of LED beads in the second LED logic unit, a signal corresponding to the plurality of LED beads in the second LED logic unit from the signals;
the i^{th} address coder-decoder resolves, based on a preset protocol and coding of the addresses of the plurality of LED beads in the i^{th} LED logic unit, a signal corresponding to the plurality of LED beads in the i^{th} LED logic unit from the signals; and
the N^{th} address coder-decoder resolves, based on a preset protocol and coding addresses of the plurality of LED beads in the N^{th} LED logic unit, a signal corresponding to the plurality of LED beads in the N^{th} LED logic unit from the signals,
so that the LED lamp synchronously controls every color channel of all the LED beads from the first LED logic unit to the N^{th} LED logic unit through the first address coder-decoder to the N^{th} address coder-decoder.

9. The LED lamp according to claim 1, wherein when any illuminating segment is replaced with a new illuminating segment due to malfunction, an address coder-decoder corresponding to the illuminating segment may recode addresses of LED beads in the new illuminating segment.

10. The LED lamp according to claim 1, wherein any address coder-decoder, other than the first address coder-decoder, can code the addresses of the plurality of LED beads in a corresponding illuminating segment in a shifting mode.
